(19) United States
(12) Patent Application Publication
(10) Pub. No.: US 2009/0219599 A1
(43) Pub. Date: Sep. 3, 2009

(54) CHANGEABLE APPARATUS FOR SINGLE OR RASTER SCANNING USING POLYGON MIRROR

(75) Inventor: Hiroshi Hayakawa, Saitama Pref. (JP)

Correspondence Address: Kaplan Gilman & Pergament LLP, 1480 Route 9 North, Woodbridge, NJ, 07095, US

(73) Assignees: OPTOELECTRONICS CO., LTD., Warabi, Saitama Pref (JP); OPTICON, INC., Orangeburg, NY (US)

(21) Appl. No.: 12/298,341

(22) PCT Filed: May 8, 2006
(86) PCT No.: PCT/US06/17557

§ 371 Date: Jan. 26, 2009

(51) Int. Cl. G02B 26/10

(52) U.S. Cl. 359/223.1

(57) ABSTRACT

A changeable apparatus for scanning a symbol is disclosed wherein by selectively changing the position of a bending mirror (101), different scan patterns are produced. In a preferred embodiment, the different positions of the bending mirror (101) result in a scanning beam (107, 108) being directed off of different polygon scanning mirrors (104, 105) to create the different scanning patterns.

### BACKGROUND OF THE INVENTION

This invention relates to optical scanning, and more particularly, to an improved method and apparatus for permitting raster scanning and linear scanning.

Laser optical scanning devices are known in the art, and are used to read a variety of one and two dimensional bar code and similar symbols. These devices are typically implemented by having a moving laser beam that repeatedly scans over the areas of black and white, or sometimes color, that are contained within a symbol to be read.

The required or optimum scanning pattern can be different depending upon the symbol to be read. For example, in cases where a bar code is of poor quality or misaligned, a raster scan pattern may be desirable. Other applications require a single linear scan that simply moves back and forth across a one dimensional bar code. Moreover, a linear scan may be implemented by using a rotating polygon mirror or an oscillating mirror. Often, an enterprise must have plural types of scanners available and deployment ready in order to be capable of reading various types of bar code symbols in an optimal manner.

To date, there exists no efficient manner of providing different types of scanning without the additional expense and difficulty of maintaining plural scanning devices.

### BRIEF DESCRIPTION OF THE DRAWINGS

FIG. 1 shows a simplified conceptual depiction of a device in accordance with the present invention;

FIG. 2 shows a side view of a mirror arrangement for use in an exemplary embodiment of the present invention;

FIG. 3 shows an exemplary motor which can be used to implement the scanning action of the present invention;

FIG. 4 depicts the motor of FIG. 3 with the mirror arrangement of FIG. 2 mounted thereon;

FIG. 5 depicts a side view of an exemplary embodiment of the present invention in operation;

FIG. 6 is a two part depiction of a mechanism for selectively positioning the bending mirror of the present invention; and

FIG. 7 shows an alternative embodiment wherein a selection between a rotating and oscillating mirror is provided.

### DETAILED DESCRIPTION OF THE PREFERRED EMBODIMENT

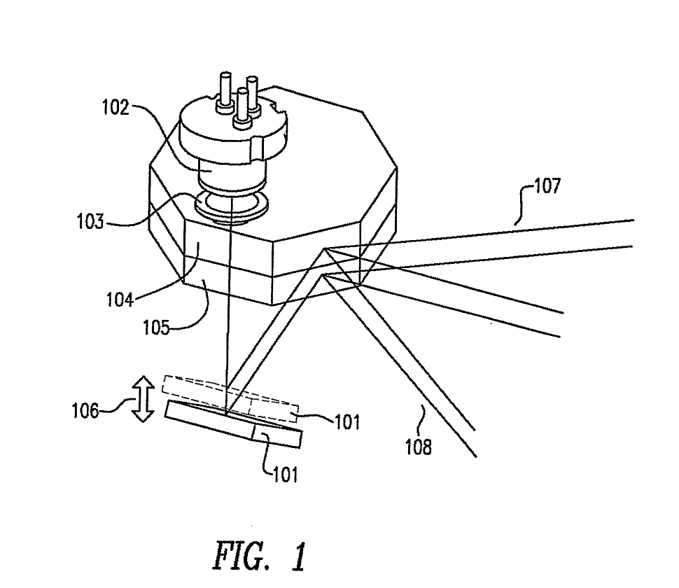

FIG. 1 depicts a conceptual diagram of an apparatus in accordance with the present invention. The apparatus of FIG. 1 includes two polygon scanning mirrors 104 and 105, which are known in the art for producing a repeated scanning function in laser scanning systems.

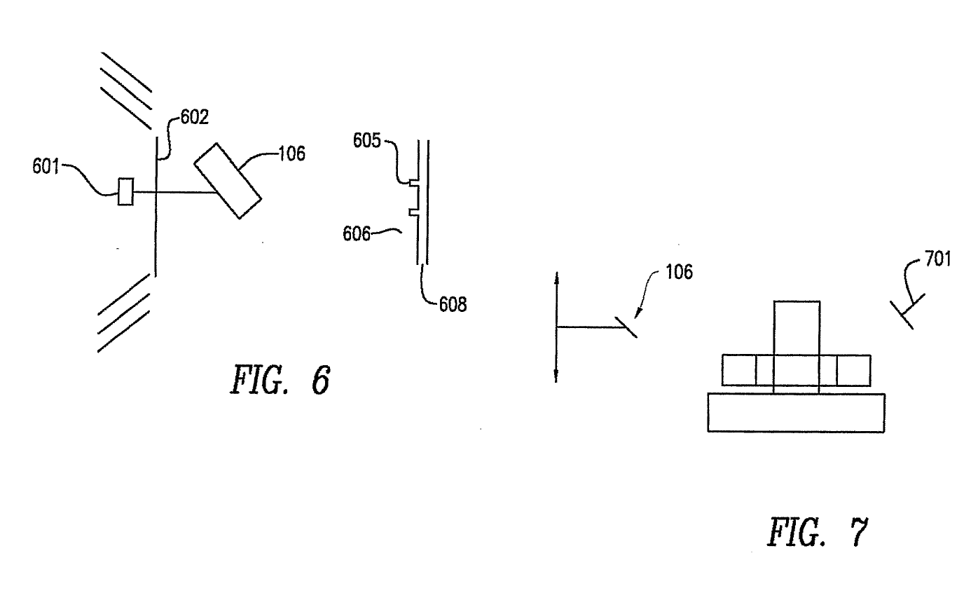

A bending mirror 101 is also shown in both solid and dotted outlines, indicating two different potential positions at which such bending mirror can be placed. Finally, switch 106 is merely shown as an arrow, but may be any system for supporting the mirror and permitting it to selectively be moved into one of two positions for operation. Further details concerning an exemplary such system are shown and described in FIG. 6.

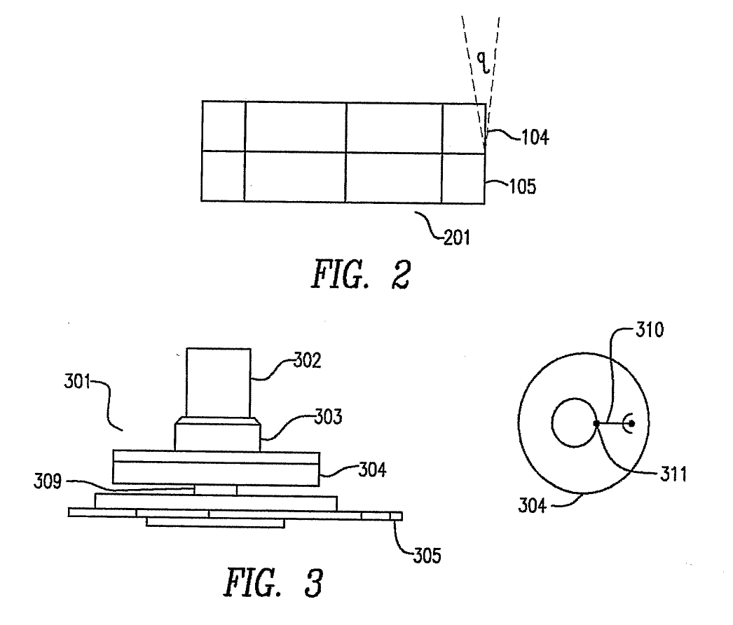

In operation, the bending mirror 101 is set at either one of the two positions shown in FIG. 1, depending upon whether it is desired to utilize polygon mirror 104 or 105 for scanning. While FIG. 1 is a prospective view of the assembled polygon mirrors, FIG. 2 shows a cross sectional view of the same two polygon mirrors in FIG. 1. It can be seen from FIG. 2 that the top polygon mirror 104 has faces that are disposed at an angle “a” with respect to the axis of rotation of the polygon mirror. As is known in the art, the use of this tilted polygon mirror 104 results in a raster scan pattern which can be utilized to scan poorly printed bar codes or other types of symbols. As shown in FIG. 2, the lower polygon scanning mirror 105 has faces that are disposed at zero angle with respect to the axis of rotation, and thus which are parallel with respect to the axis of rotation.

Returning to FIG. 1, in operation, the bending mirror 101 is positioned in its upper dotted position or its lower, depending upon whether a raster scan or a linear scan is desired, respectively. This positioning may be accomplished by mounting the bending mirror on a support (not shown) and providing a means to move the support as described later herein.

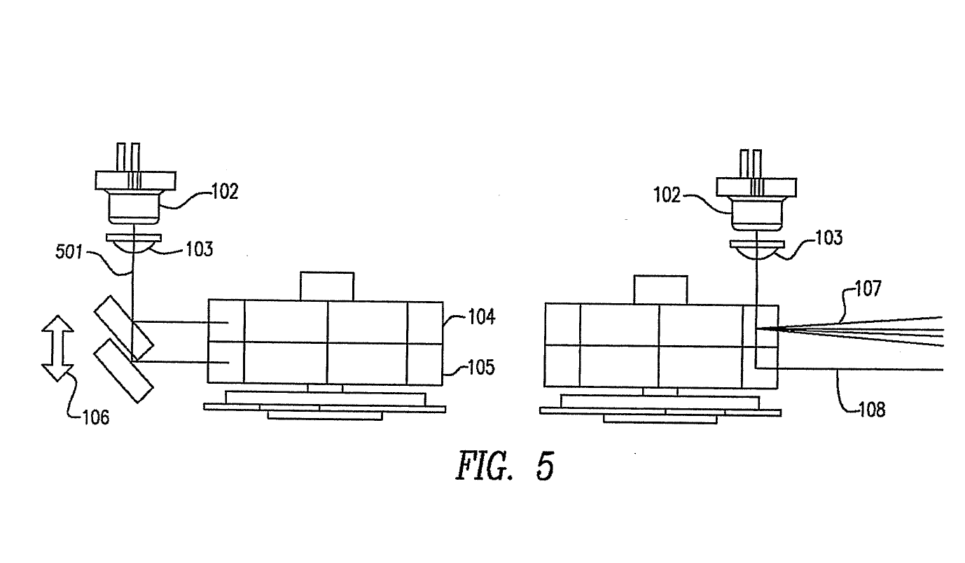

A light source 102 then transmits the laser light through lens 103. The light is deflected off of the bending mirror 101 and on to the appropriate polygon scanning mirror 104 or 105. The resulting pattern of emitted light is shown in FIG. 1 as beams 107 and 108, but can be seen more clearly in FIG. 5, which shows the different potential scanning patterns that emanate from polygon scanning mirror 104 or 105.

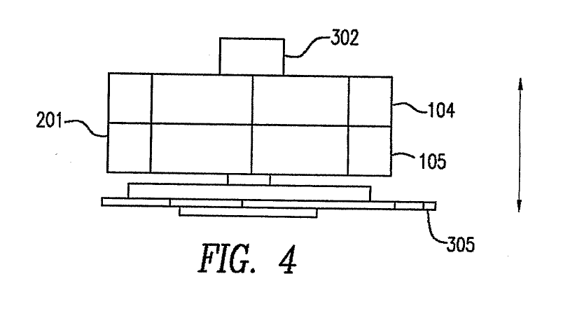

FIG. 3 is a basic diagram of an exemplary motor for use in accordance with the present invention. In the arrangement in FIG. 3, a shaft 302 includes wider portions 303 and 304, which are rotated under electric power to cause the scanning in accordance with conventional techniques. This is best seen in FIG. 4, where mirrors 104 and 105 have been mounted on shaft 302 of motor 301.

Ideally, the underside of the two stage polygon mirror 201 of FIG. 2 has an opening that fits directly over portions 303 and 304, so that it may compliment the shape thereof. More specifically, the underside of mirror 105 is wide enough to fit over portion 304, while the underside of mirror 104 fits directly over wider portion 303. The bore through portion 104 continues, so that the shaft 302 protrudes from the top of polygon scanning mirror 104 as shown in FIG. 4. The two stage polygon mirror 201 may then be secured to the shaft 302 by a clip, nut, or any conventional technique for preventing the polygon mirror 201 from slipping off of the shaft 302.

In alternative embodiments, the attachment of two stage polygon mirror 201 may be via use of a clip or other attachment means that can be positioned at two different places along the shaft 302. For example, the bottom of the portion 304 of shaft 302 could include a spring loaded stub that sits in a small opening along shaft 309, and the openings along shaft 309 could provide for different positions of the rotating polygon mirrors 104 and 105. Thus, to change positions, the stub 310 is pulled from the opening 311, the arrangement slid up or down as shown in FIG. 4 by the arrows, and the spring loaded stub reinserted. FIG. 5 shows front and side views of the arrangement in operation, wherein both potential paths of the light beam are shown. As can be seen best from the side view shown in FIG. 5, a user may implement a raster scan or linear scan by simply switching the bending mirror 101 to one of two different positions.

In an enhancement, the system may be sold with a plurality of different mirrors that can be mixed and matched to derive any specific combination. More specifically, the distance between scan lines of a raster scan is effected largely by the particular angle as shown in FIG. 2. The system can be sold with several different polygon scanning mirrors 104 having different angles a, different dimensions, etc. In an enhanced embodiment, a set can be sold as a configurable optical scanner, where in various different mirrors can be mixed and match to create a custom device.

FIG. 6 shows one exemplary embodiment for permitting the bending mirror 101 to be moved between the two desired positions. The arrangement includes a switch 601 mounted to a shaft that supports the mirror and which may be slideable upward and downward through a grove 608. The grove 608 includes two notches 605 and 606 into which the shaft may be slid to support the bending mirror in either of two positions.

While the arrangement of FIG. 6 is one exemplary manner in which the bending mirror 101 may be moved, it will be apparent to those of skill of the art that a variety of techniques may be utilized for this function.

It is also noted that while two polygon scanning mirrors 104 and 105 are shown, more than two scanning mirrors may be used as well. While scanning mirrors 104 and 105 are both polygon scanning mirrors, the bending mirror may be positioned to steer a beam 501 to a different type of scanner other than a polygon mirror.

For example, the bending mirror 101 could be alternatively positioned to steer the beam 501 to a scanning mirror that simply oscillates, rather than a polygon. FIG. 7 shows such an arrangement wherein the bending mirror 101 may, be moved to direct the beam at a rotating polygon scanning mirror 702 or a linear oscillating scanning mirror 701.

Moreover, a plural function device could incorporate a polygon scanning mirror as well, wherein, in one of several positions, the bending mirror 101 directs the beam 501 to a scanning mirror which further directs it to an omni directional scanner so that the device is selectable between and/or among a variety of different scanning patterns. Omnidirectional scanning mirrors are normally implemented by having a single rotating polygon mirror and several static mirrors. Thus, the bending mirror could be directed at the rotating polygon mirror, which then directs the beam to the static mirrors.

The bending mirror is also itself optional, as the light source could be directed at the rotating or oscillating mirror, without being bent. In such embodiments, the light source itself could be movable, to serve the selection function otherwise served by the bending mirror.

The foregoing is intended to be exemplary only, and does not limit the scope of the following claims.

1. A device for scanning a laser over a symbol to be read, said device comprising at least two different reflecting surfaces for directing a scanning beam towards a target, and a movable support for moving an incoming beam so that it may be selectively directed to a selected one of said at least two reflecting surfaces.

2. The device of claim 1 further comprising a bending mirror mounted on said support, said bending mirror being movable by moving the support to reflect the incoming beam to the selected one of said at least two reflecting surfaces.

3. The device of claim 1 wherein a first of said reflecting surfaces causes a raster scan and a second of said reflecting surfaces causes a linear scan.

4. The device of claim 3 further comprising a third reflective surface that implements an omnidirectional scan.

5. The device of claim 3 further comprising a slot with a first stop point and a second stop point, and wherein the support is movable between said first and second stop points and may be fixed in either of said stop points.

6. A device for implementing a selected mode of scanning, said device comprising a rotating motor with at least two different reflecting surfaces mounted thereon for rotation about an axis, at least a first of said reflecting surfaces having facets that are disposed at a first angle with respect to said axis of rotation, and at least a second of said reflecting surfaces having facets that are disposed at a second angle with respect to said axis of rotation, said first and second angles being different from each other.

7. The device of claim 6 wherein at least one of said first and second angles is zero.

8. The device of claim 7 further comprising a bending mirror that may be set to cause a beam to be incident upon either the first reflecting surface or the second reflecting surface.

9. The device of claim 7 wherein a movable light source is employed, said movable light source being selectively configurable to direct a beam such that it is incident upon either the first reflecting surface or the second reflecting surface.

10. The device of claim 6 wherein said first and second reflecting surfaces are selectively movable so that either can be moved into a path of the beam.

11. A device comprising a bending mirror selectively movable to one of at least two positions, each one of said at least two position of said bending mirror transmitting an incoming beam to a different scanning mirror.

12. The device of claim 11 wherein one of said scanning mirrors is a rotating polygon mirror and another of said scanning mirrors is a flat oscillating mirror.

13. A scanning device comprising a light source mounted on a selectively movable support that may be moved to a first or second position, wherein the light source produces a different scanning pattern depending upon whether it is in the first or second position.

14. The scanning device of claim 13 wherein the light source produces either a raster scan or a linear scan.
